(19) United States
(12) Patent Application Publication
(10) Pub. No.: US 2008/0247096 A1
(43) Pub. Date: Oct. 9, 2008

(54) MAGNETIC MEMORY AND METHOD FOR MANUFACTURING THE SAME

(75) Inventors: Yuan-Jen Lee, Taipei County (TW); Ding-Yeong Wang, Hsinchu County (TW); Chien-Chung Hung, Taipei City (TW)

Correspondence Address: J C PATENTS, INC., 4 VENTURE, SUITE 250, IRVINE, CA, 92618, US

(73) Assignee: INDUSTRIAL TECHNOLOGY RESEARCH INSTITUTE, Hsinchu (TW)

(21) Appl. No.: 11/754,824

(22) Filed: May 29, 2007

(30) Foreign Application Priority Data
Mar. 26, 2007 (TW) 96110329

(51) Int. Cl. G11B 5/33; G11B 5/147; G11B 5/66

(52) U.S. Cl. 360/324.2; 427/58; 427/126.6

(57) ABSTRACT

A magnetic memory including a stack, a first writing wire, and a second writing wire is provided. The stack includes a magnetic pinned layer, a tunnel barrier insulating layer, and a magnetic free layer, so as to form a magnetic tunnel junction (MTJ). The MTJ has an easy axis. The first writing wire is disposed under the stack. The included angle between the first writing wire and the easy axis of the MTJ is smaller than 45 degrees and greater than 0 degrees on a projected plane. The second writing wire is disposed above the stack. The included angle between the second writing wire and the easy axis of the MTJ is smaller than 45 degrees and greater than 0 degrees on the projected plane.

### CROSS-REFERENCE TO RELATED APPLICATION

This application claims the priority benefit of Taiwan application serial no. 96110329, filed on Mar. 26, 2007. All disclosure of the Taiwan application is incorporated herein by reference.

### BACKGROUND OF THE INVENTION

1. Field of the Invention

The present invention relates to a memory. More particularly, the present invention relates to a magnetic memory and a method for manufacturing the same.

2. Description of Related Art

Magnetic memories, e.g., magnetic random access memories (MRAMs), are also a kind of non-volatile memory. The magnetic memory has advantages of non-volatility, high density, high reading and writing speed, and radiation resistance and so on. FIG. 1 shows the basic structure of a conventional magnetic memory cell. Referring to FIG. 1, the magnetic memory 104 has a stacked structure, and includes a magnetic pinned layer, a tunnel barrier insulating layer, and a magnetic free layer. The magnetic pinned layer has a fixed magnetization or a total magnetic moment in a predetermined direction. The magnetic memory cell 104 uses the magnetizations of magnetic materials (the magnetic pinned layer and the magnetic free layer) adjacent to the tunnel barrier insulating layer to record data of “0” or “1”. The generated magnetic resistance is smaller when the magnetizations of the magnetic pinned layer and the magnetic free layer are parallel, and is greater when the magnetizations of the two layers are anti-parallel. Therefore, the magnetic memory cell 104 can be used to record the data of “0” or “1”.

In order to access a magnetic memory cell, current lines 100 and 102 (generally referred to as a word line and a bit line according to the operation modes) vertically intersecting and carrying appropriate currents are required. After the currents are applied to the lines 100, 102 that are perpendicular to each other, two magnetic fields that are perpendicular to each other are generated. The magnetic fields generated by the lines 100 and 102 are applied to the magnetic cell 104. When writing data, the magnetic memory cell into which the data will be written is selected according to the intersection of the bit line (BL) and the word line (WL) 100, 102. The direction of the magnetization of the magnetic free layer is changed according to the induced magnetic fields of the bit line and the word line 100, 102, so as to change the magnetic resistance value of the magnetic memory cell 104. When reading data, output electrodes 106, 108 are used to allow a current to flow into the selected memory cell, and the digital value of the memorized data can be determined according to the read resistance value. Operating principles of the magnetic memories are well known to persons of ordinary skill in the art, and will not be described herein.

FIG. 2 shows a memory mechanism of a magnetic memory. As shown in FIG. 2, a magnetic pinned layer 104a has a fixed magnetic moment direction 107. A magnetic free layer 104c is located above the magnetic pinned layer 104a, and a tunnel barrier insulating layer 104b is sandwiched therebetween for providing isolation. The magnetic free layer 104c has a magnetic moment direction 108a or 108b. When the magnetic moment direction 107 and the magnetic moment direction 108a are parallel, for example, the generated magnetic resistance denotes the data of “0”. On the contrary, when the magnetic moment direction 107 and the magnetic moment direction 108b are anti-parallel, for example, the generated magnetic resistance denotes the data of “1”.

For a magnetic memory cell, the relationship between the magnetic resistance (R) and the intensity of the magnetic field H is shown in FIG. 3. The solid line denotes a magnetic resistance line of a single magnetic memory cell. However, as a magnetic memory device includes a plurality of memory cells, and each of the memory cells may have a different switching field, the magnetic resistance curve will have changes (shown as the dashed lines), which may lead to failure of access.

FIG. 4 shows an array structure of a conventional memory cell. The left figure of FIG. 4 shows an array structure composed of a plurality of bit lines and word lines perpendicular to the bit lines. One magnetic memory cell 104 is disposed at each of the intersections of the bit lines and the word lines. Magnetic fields Hx and Hy in two directions are applied by currents in the bit lines and the word lines, so as to write data into the magnetic memory cell 104. The right figure of FIG. 4 shows asteroid curves of the magnetic free layer. In the area indicated by the solid lines, as the magnetic field is small, the external magnetic fields Hx and Hy do not change the direction of the magnetization of the memory cell 104. The magnetic field in a limited area outside the solid lines is suitable for the operation of magnetic field switching. If the magnetic field is too large, the neighboring memory cells will be interfered, so it is not applicable as well. Therefore, normally, the magnetic field in the operation area 144 is used as the operating magnetic field. However, as other memory cells 142 also sense the applied magnetic fields, and the operating conditions of the neighboring memory cells 142 change, the applied magnetic fields may also change the data stored in other memory cells 142. Thus, the single-layered free layer 104c as shown in FIG. 2 may have access errors.

In order to solve the above problems, for example, U.S. Pat. No. 6,545,906 uses a three-layer structure 166 including a ferromagnetic layer (FM)/a non-magnetic metal layer (M)/a ferromagnetic layer (FM) instead of the single-layered ferromagnetic material serving as the free layer, so as to reduce the interference of the neighboring cells when writing data. As shown in FIG. 5, the ferromagnetic metal layers 150, 154 above and under the non-magnetic metal layer 152 are arranged in anti-parallel, so as to form closed magnetic lines of force. A magnetic pinned layer 168 beneath is isolated from the magnetic free layer 166 by a tunnel barrier insulating layer 156. The magnetic pinned layer 168 includes a top pinned layer (TP) 158, a non-magnetic metal layer 160, and a bottom pinned layer (BP) 162. The top pinned layer and the bottom pinned layer have fixed magnetization. Moreover, a substrate 164 is arranged at the bottom, which for example is an anti-ferromagnetic layer (AFM).

According to the three-layered magnetic free layer 166, the magnetic anisotropic axes of a first writing line and a second writing line relative to the free layer 166 are adjusted to form an included angle of 45 degrees. At this time, the direction of the magnetic anisotropic axis is called the direction of the easy axis. Thus, the first writing line and the second writing line can apply magnetic fields having an included angle of 45 degrees with respect to the magnetic free layer 166 sequentially, so as to rotate the magnetization of the magnetic free layer 166. FIG. 6 shows the time sequence of applying the magnetic fields. In FIG. 6, the upper figure shows the direction of the easy axis (indicated by the double arrow) relative to the magnetic field directions. The lower figure in FIG. 6 shows the time sequence of applying currents to the first writing line and the second writing line. The current I₁ generates the magnetic field at an angle of +45 degrees with respect to the easy axis, i.e., the vertical axis in the upper figure. The current I₂ generates the magnetic field at an angle of −45 degrees with respect to the easy axis, i.e., the horizontal axis in the upper figure. According to the time sequence for applying currents, the magnetization directions of the ferromagnetic layers 150, 154 above and under the magnetic free layer 166 will be switched. The time sequence for applying currents is realized by two states, which is also called a toggle mode operation. Each time the toggle mode operation is performed, the magnetization directions of the two ferromagnetic layers 150, 154 above and under the magnetic free layer 166 are reversed once. As the magnetization direction of the top pinned layer 158 is fixed, the magnetization direction of the lower ferromagnetic layer 154 and the magnetization direction of the top pinned layer 158 will be parallel or anti-parallel. Thus, a binary data is stored.

FIG. 7 shows the reaction between the magnetizations of the two ferromagnetic layers 150, 154 above and under the magnetic free layer 166 and the intensity of the external magnetic fields. Referring to FIG. 7, in situation (a), the thin arrows indicate the magnetization directions of the two ferromagnetic layers 150, 154 above and under the magnetic free layer 166. In situation (b), when the intensity of the external magnetic fields H (the thick arrow) is low, the two magnetization directions will not be changed. In situation (c), when the intensity of the external magnetic fields H increases to an appropriate value, the magnetization directions of the ferromagnetic layers 150, 154 will be influenced by the magnetic field H to achieve a balanced state. Thus, an angle appears. At this time, the scope of the magnetic field is the area of toggle operation in the toggle mode, and the rotation of the magnetizations is the change of the magnetic fields in two directions that are perpendicular to each other according to a specific time sequence (as shown in FIG. 6). Therefore, the magnetizations are switched in several stages. However, in situation (d), if the intensity of the magnetic field H is too large, the directions of the two magnetizations are always guided to a direction identical to that of the magnetic field H, which is not an appropriate operation area.

FIG. 8 shows the switching mechanism when the magnetic field generated by the operating current of FIG. 6 is applied to the memory cells. Referring to FIG. 8, in the time period t₀, as no magnetic field is applied, the magnetizations of the ferromagnetic layers 150, 154 on the free layer are anti-parallel. In the period t₁, a magnetic field H₁ is applied to the magnetic free layer at the direction of +45 degrees to the easy axis. At this time, the magnetizations of the ferromagnetic layers 150, 154 are rotated according to the direction of the applied magnetic field. In the period t₂, a magnetic field H₂ is applied at the same time. The direction of the magnetic field H₂ is −45 degrees relative to the direction of the easy axis. Therefore, if the intensities of the two magnetic fields are the same, the direction of the total magnetic field is in the direction of the easy axis. At this time, the magnetizations of the ferromagnetic layers 150, 154 are rotated again. Then, in the period t₃, it stops applying the magnetic field H₁. At this time, the total magnetic field is provided by the magnetic field H₂, so the magnetizations of the ferromagnetic layers 150, 154 are rotated again. It should be noted that in the period t₃, the magnetizations of the ferromagnetic layers 150, 154 almost have been reversed relative to an axis. Thus, in the period t₄, when the external magnetic fields disappear, the two magnetizations return to the direction of the easy axis in the anti-parallel state, and the magnetizations of the ferromagnetic fields 150, 154 are switched.

FIG. 9 shows corresponding operation areas relative to the external magnetic field. Referring to FIG. 9, the toggle operation mode of FIG. 8 corresponds to toggle areas 97 among the operation fields in the magnetic field coordinates. Other areas in the coordinates include non-switching areas 92 and direct areas 95. The direct areas 95 are between the non-switching areas 92 and the toggle areas 97, and the details are not described herein.

A U.S. Pat. No. 6,633,498 provides a design having reduced operating magnetic fields. FIG. 10 is a schematic view of the design having reduced operating magnetic fields. Referring to FIG. 10, the conventional design adjusts the total magnetic moment 170, 172 of a top pinned layer 158 and a bottom pinned layer 162 of a magnetic pinned stack, so as to generate a leakage magnetic field. The leakage magnetic field will enable generation of a bias field H_{BIAS} to the magnetic free layer, as shown in the right figure. The start point of the toggle operation area is close to the zero point of the magnetic field. The total magnetic moment can be simply adjusted by adjusting the thickness.

According to the conventional art described above, although the start point of the toggle operation area can get close to the zero point of the magnetic field by adjusting the intensity of the bias field H_{BIAS}, the increase in the intensity of the bias field H_{BIAS} is limited. After careful study of the conventional art, it is found that if the bias field H_{BIAS} is too large, at least the data stored in the memory cells is interfered directly, which will lead to the failure of data access.

### SUMMARY OF THE INVENTION

The present invention is directed to a magnetic memory and a method for manufacturing the same, which can increase operation areas at low currents and reduce interference when writing data. When elements are miniaturized, the present invention maintains superior switching performance and adequate thermal stability.

As embodied and broadly described herein, a magnetic memory provided by the present invention includes a stack, a first writing wire, and a second writing wire. The stack includes a magnetic pinned layer, a tunnel barrier insulating layer, and a magnetic free layer, so as to form a magnetic tunnel junction (MTJ). The MTJ has an easy axis. The first writing wire is disposed under the stack. The included angle between the first writing wire and the easy axis of the MTJ is smaller than 45 degrees and greater than 0 degrees on a projected plane. The second writing wire is disposed above the stack. The included angle between the second writing wire and the easy axis of the MTJ is smaller than 45 degrees and greater than 0 degrees on the projected plane.

The present invention also provides a method for manufacturing a magnetic memory. First, a substrate is provided. A first writing wire is formed above the substrate. A stack is formed above the first writing wire. The stack includes a magnetic pinned layer, a tunnel barrier insulating layer, and a magnetic free layer, so as to form a magnetic tunnel junction (MTJ), in which the MTJ has an easy axis. An included angle between the first writing wire and the easy axis of the MTJ is smaller than 45 degrees and greater than 0 degrees on a projected plane. A second writing wire is formed above the stack. The included angle between the second writing wire and the easy axis of the MTJ is smaller than 45 degrees and greater than 0 degrees on the projected plane.

As the included angles between the writing wires and the easy axis of the MTJ are smaller than 45 degrees (i.e., the included angle between the two writing wires is smaller than 90 degrees), the intensity of a bias field H_{BIAS} is increased, so that a start point of a toggle operation area gets close to a zero point of the magnetic field. Thus, the operation area at low currents is increased, and the interference when writing data is reduced. In particular, when elements are miniaturized, the present invention maintains superior switching performance and adequate thermal stability.

In order to the make aforementioned and other objects, features and advantages of the present invention comprehensible, preferred embodiments accompanied with figures are described in detail under.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a farther understanding of the invention, and are incorporated in and constitute a part of this specification. The drawings illustrate embodiments of the invention and, together with the description, serve to explain the principles of the invention.

FIG. 1 shows a basic structure of a conventional magnetic memory cell.

FIG. 2 shows a memory mechanism of the conventional magnetic memory.

FIG. 3 shows a relationship between a magnetic resistance (R) and an intensity of the magnetic field H of a magnetic memory cell.

FIG. 4 shows an array layout of the conventional memory cell.

FIG. 5 shows the basic structure of the conventional memory cell.

FIG. 6 shows a layout of the conventional memory cell and a time sequence for applying magnetic fields.

FIG. 7 shows a reaction between the magnetizations of the two ferromagnetic layers 150, 154 above and under the magnetic free layer 166 and the intensity of the external magnetic fields.

FIG. 8 shows a switching mechanism when the magnetic field generated by the operating current of FIG. 6 is applied to the memory cells.

FIG. 9 shows corresponding operation areas of the two magnetizations of the two free layers relative to the external magnetic fields.

FIG. 10 is a schematic view of a design having reduced operating magnetic fields.

FIG. 11 shows success probability of simulating the switching of magnetization of the free layer based on micromagnetism when the thickness of the bottom pinned layer 162 of FIG. 10 is changed according to an embodiment of the present invention.

FIGS. 12A-12B are schematic views of the relationship between the bias field and the external operating magnetic fields according to an embodiment of the present invention.

FIG. 13 shows the difference between the direction of the bias field and that of the ideal magnetic field according to an embodiment of the present invention.

FIG. 14 is a layout diagram of a magnetic memory according to an embodiment of the present invention.

FIG. 15 is a layout diagram of another magnetic memory 1500 according to an embodiment of the present invention.

FIG. 16 is a vector diagram of the bias field and the external magnetic fields according to an embodiment of the present invention.

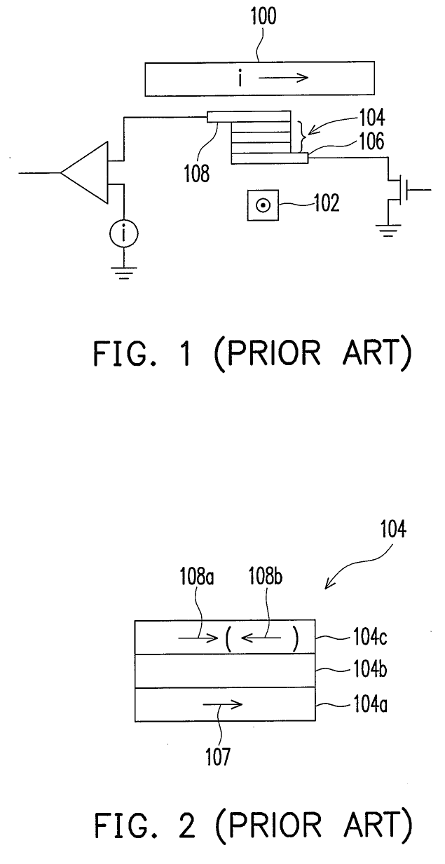

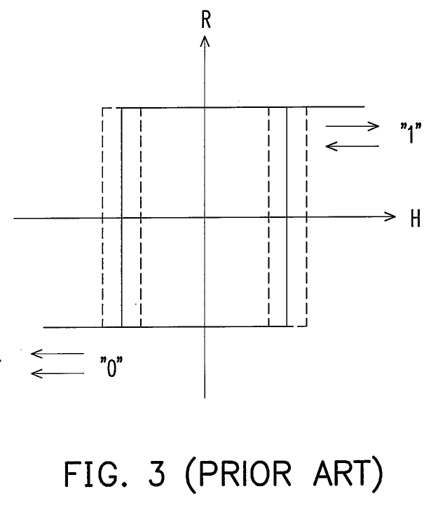

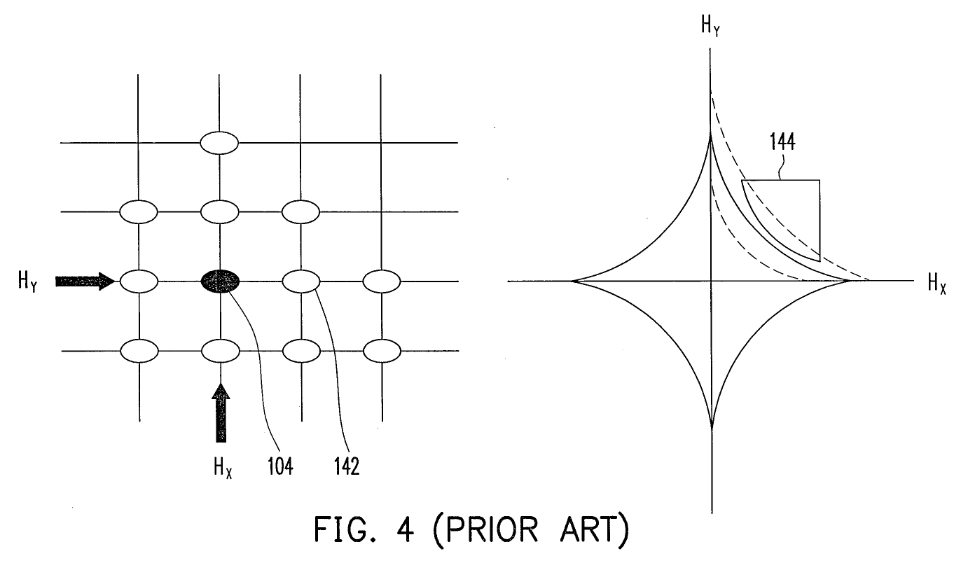

### DESCRIPTION OF EMBODIMENTS

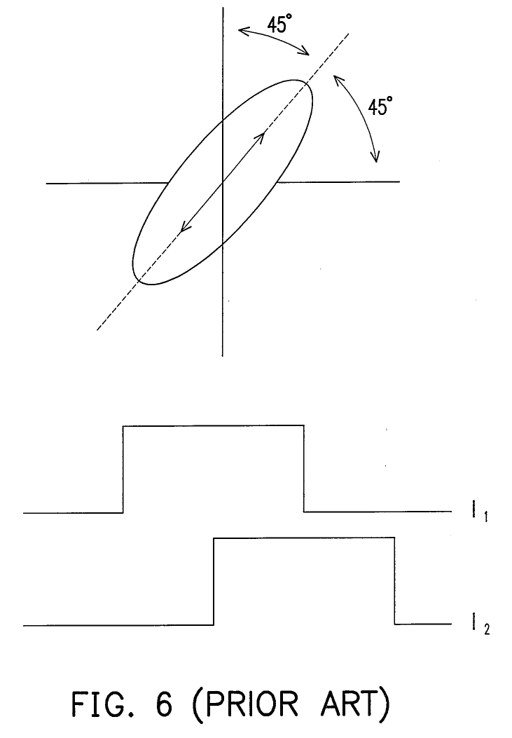

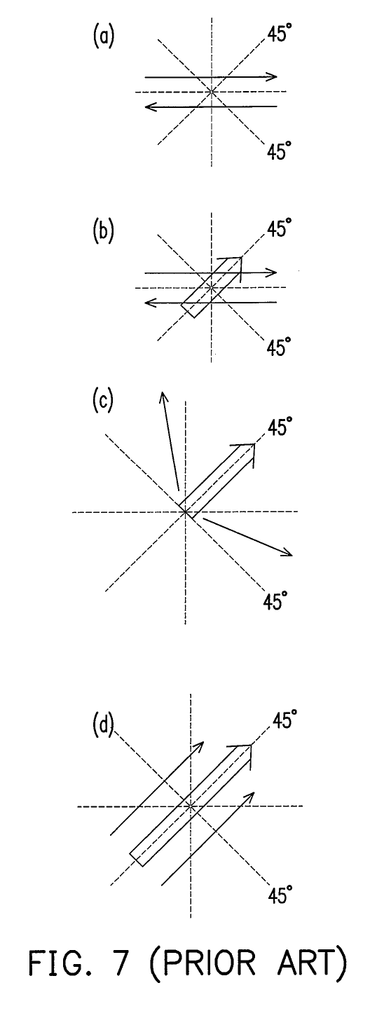

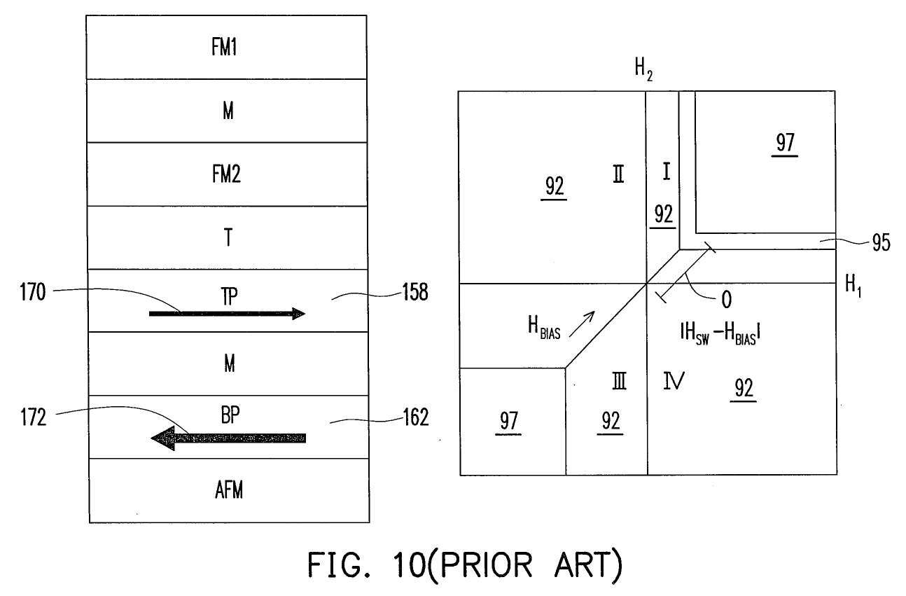

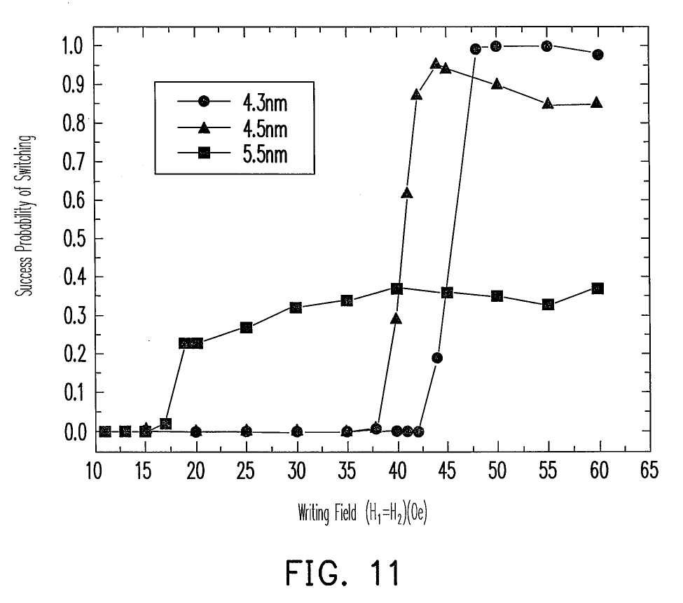

In the present invention, the thickness of the bottom pinned layer 162 of FIG. 10 is changed, so as to measure the probability of success of the switching of the magnetization of the free layer. The result of the micromagnetic simulation is shown in FIG. 11. Referring to FIG. 11, the data of round points indicates the situation when the thickness is 4.3 nm, the data of triangular points indicates the situation when the thickness is 4.5 nm, and the data of square points show the situation when the thickness is 5.5 nm. When the thickness becomes greater, the intensity of the bias field becomes larger. As for the writing magnetic field of FIG. 6, if H₁=H₂, the intensity of the magnetic field of H₁ or H₂ is used as the abscissa. Here, a thickness 3.0 nm is taken as a reference thickness of the top pinned layer 158. According to the distribution of the round points, when the magnetic filed is about 43 Oe, a pair of magnetic moments of the magnetic free layer can be switched successfully, and the probability of success of switching remains at a fine level. When the thickness of the bottom pinned layer 162 increases, according to the distribution of the triangular points, the operating magnetic field can be reduced, and the probability of success of switching remains at an acceptable range. When the thickness of the bottom pinned layer 162 increases to 5.5 nm, although the magnetic field with a higher intensity is generated to reduce the intensity of the magnetic field required for switching (about 17 Oe), the probability of success of switching is no larger than 40% (indicated by the distribution of the square points). Therefore, the thickness of the conventional bottom pinned layer 162 is limited, and in case that the thickness exceeds the limit, the element cannot operate successfully.

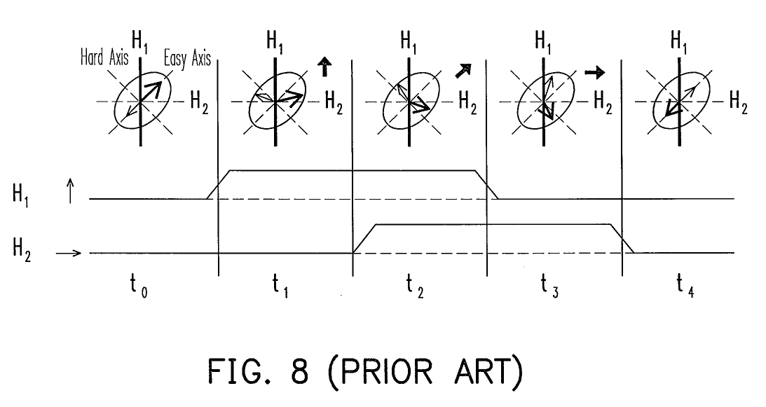

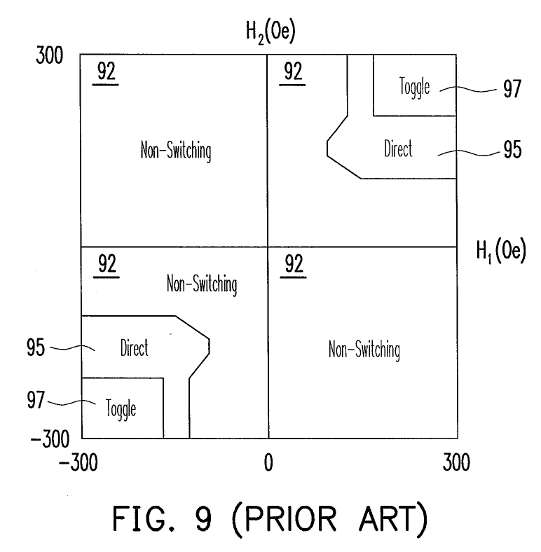

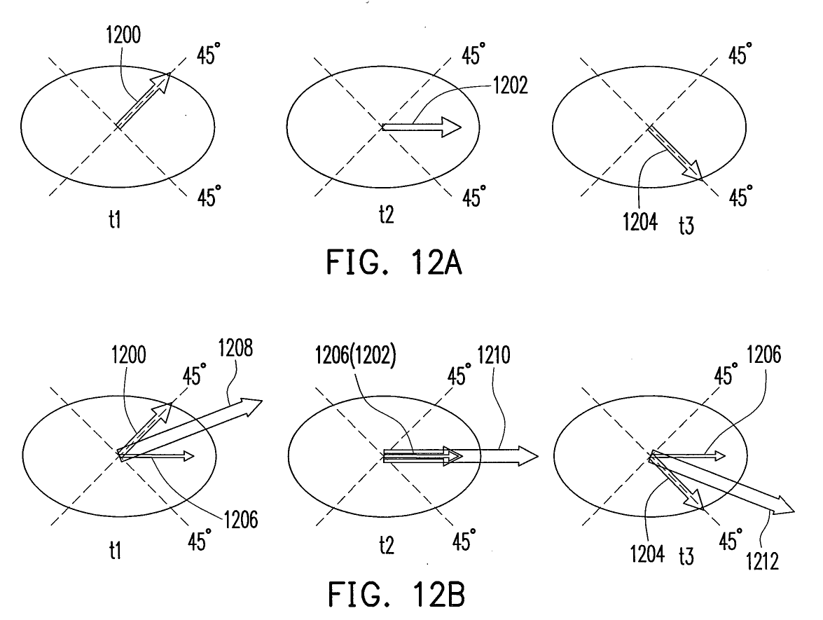

The present invention further discusses possible mechanisms and solutions directed to the above problems. FIGS. 12A-12B are schematic views of the relationship between the bias field and the conventional external operating magnetic fields. Referring to FIG. 12A, as the magnetic field is an addable vector, during the three periods t₁-t₃ of FIG. 8, the external operating magnetic fields applied in a direction relative to the easy axis are 1200, 1202, and 1204 respectively. The directions of the dashed lines denote included angles of 45 degrees with respect to the easy axis. Referring to FIG. 12B, the leakage magnetic field of the magnetic pinned layer 168 of the memory cell will apply a bias field 1206 to the magnetic free layer 166. Therefore, the total magnetic fields in the three periods t₁-t₃ are 1208, 1210, and 1212 respectively. Obviously, the total magnetic fields 1208 and 1212 in the periods t₁ and t₃ are not in the expected desired directions. The above reasons may lead to failure of switching.

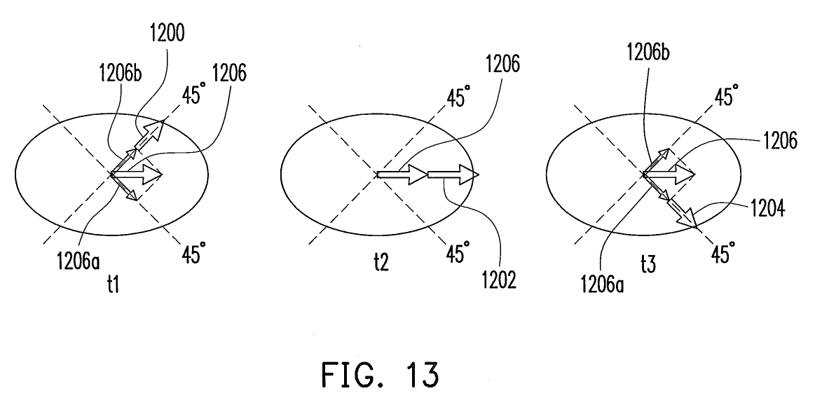

After learning the possible reasons, the present inventors further analyzed the mechanisms so as to seek solutions for resolving the problems. FIG. 13 shows the difference between the direction of the bias field and that of the ideal magnetic field according to an embodiment of the present invention. Referring to FIG. 13, the bias field 1206 is partitioned into two vector components 1206a, 1206b that are at 45 degrees. In the period t₁ (in the left figure), as the vector component 1206b is in the expected desired direction, the expected actual operating magnetic field 1200 can be reduced. That is, the writing current can be reduced. The effective magnetic field (i.e., 1206b+1200) at 45 degrees is still large enough. At this time, the problem to be solved includes how to overcome the excessive vector component 1206a. In the period t₂ (in the middle figure), as the bias field 1206 is in the direction of the easy axis, the obtained effective magnetic field is the bias field 1206 plus a composite vector 1202 of the operating magnetic fields 1200 and 1204. In the period t₃ (in the right figure), similar to the period t₁, the excessive vector component 1206b needs to be solved.

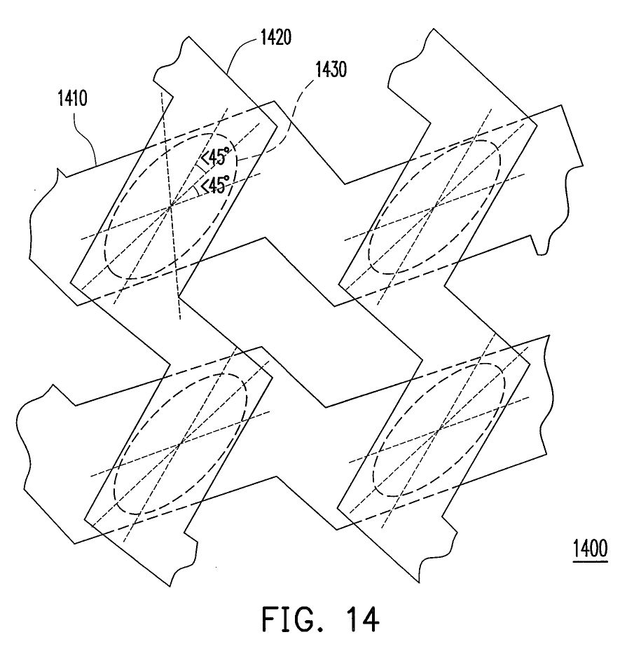

FIG. 14 is a layout diagram of a magnetic memory according to an embodiment of the present invention. The magnetic memory 1400 includes a stack, a first writing wire 1410, and a second writing wire 1420. The stack includes a magnetic pinned layer, a tunnel barrier insulating layer, and a magnetic free layer, so as to form a magnetic tunnel junction (MTJ) 1430. The MTJ 1430 has an easy axis, which can be the magnetic anisotropic axis of the magnetic free layer.

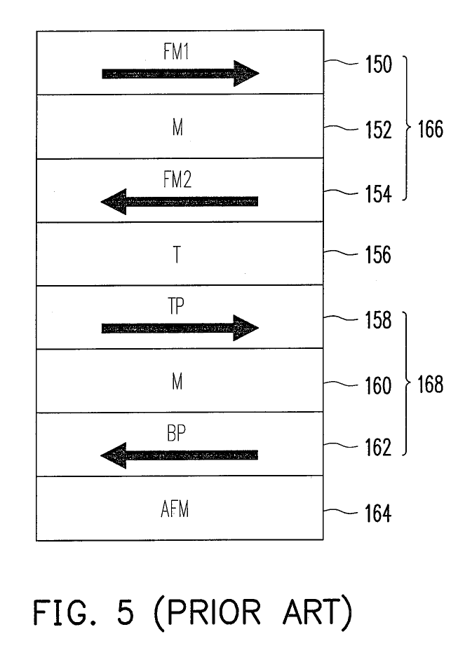

In this embodiment, the stack can be implemented with reference to FIG. 5. The stack includes a magnetic pinned layer 168, a tunnel barrier insulating layer 156 (e.g., AlOₓ or MgO), and a magnetic free layer 166, so as to form the MTJ 1430. The magnetic pinned layer 168 and the magnetic free layer 166 can be synthetic anti-ferromagnetic (SAF) layers. The magnetic pinned layer 168 includes a first ferromagnetic layer 162 (e.g., CoFe, CoFeB, NiFe, or NiFeCr), a first non-magnetic metal layer 160 (e.g., Ru or Cu), and a second ferromagnetic layer 158 (e.g., CoFe, CoFeB, NiFe, or NiFeCr). The magnetic pinned layer 168 includes a third ferromagnetic layer 154 (e.g., CoFe, CoFeB, NiFe, or NiFeCr), a second non-magnetic metal layer 152 (e.g., Ru or Cu), and a fourth ferromagnetic layer 150 (e.g., CoFe, CoFeB, NiFe, or NiFeCr).

The total magnetic moment of the first ferromagnetic layer 162 and the second ferromagnetic layer 158 of the magnetic pinned layer 168 are adjusted properly. Here, the total magnetic moment can be adjusted by deciding the thicknesses of the ferromagnetic layers 162 and 158. As described above, the total magnetic moment of the ferromagnetic fields 162 and 158 are not the same, so a leakage magnetic field is generated. The leakage magnetic field provides a bias field H_{BIAS} to the magnetic free layer 166, so that the start point of the toggle operation area gets close to the zero point of the magnetic field.

Referring to FIG. 14, the first writing wire 1410 is disposed under the stack. The included angle between the first writing wire 1410 and the easy axis of the MTJ 1430 is smaller than 45 degrees and greater than 0 degrees on a projected plane. The second writing wire 1420 is disposed above the stack. The included angle between the second writing wire 1420 and the easy axis of the MTJ 1430 is smaller than 45 degrees and greater than 0 degrees on the projected plane. For example, the included angle between the first writing wire 1410 and the easy axis of the MTJ 1430 is −35 degrees, and the included angle between the second writing wire 1420 and the easy axis of the MTJ 1430 is +35 degrees. The included angle between the writing wire 1410 or 1420 and the easy axis of the MTJ 1430 can be decided according to actual requirements (e.g., the intensity of the bias field H_{BIAS}) of the design.

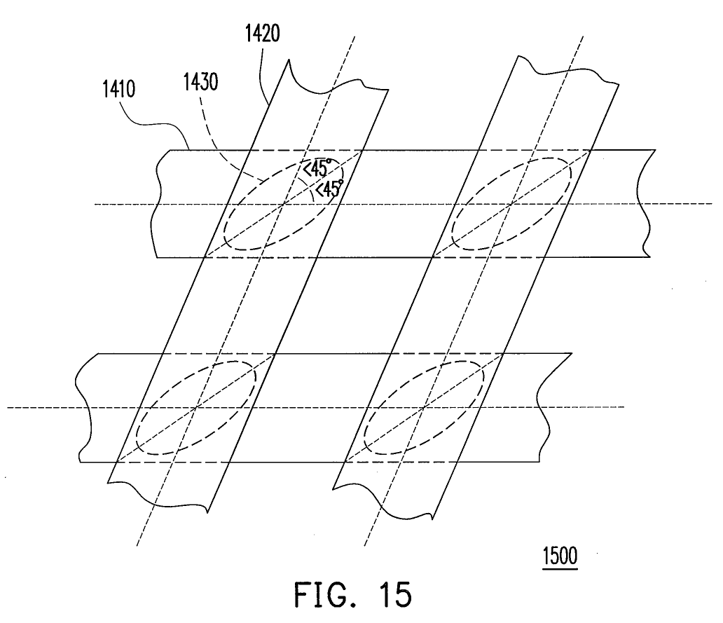

Users of the present invention can also realize the magnetic memory in other layout patterns according to the spirit of the present invention. For example, FIG. 15 is a layout diagram of another magnetic memory 1500 according to an embodiment of the present invention. Referring to FIG. 15, the first writing wire 1400 of the magnetic memory 1500 is disposed under the stack, and the second writing wire 1420 is disposed above the stack. On a projected plane, the included angle between the first writing wire 1410 and the easy axis of the MTJ 1430 is smaller than 45 degrees and greater than 0 degrees, and the included angle between the second writing wire 1420 and the easy axis of the MTJ 1430 is smaller than 45 degrees and greater than 0 degrees. That is, the included angle between the first writing wire 1410 and the second writing wire 1420 is smaller than 90 degrees and greater than 0 degrees, and the easy axis of the MTJ 1430 is included in the acute angle between the first writing wire 1410 and the second writing wire 1420.

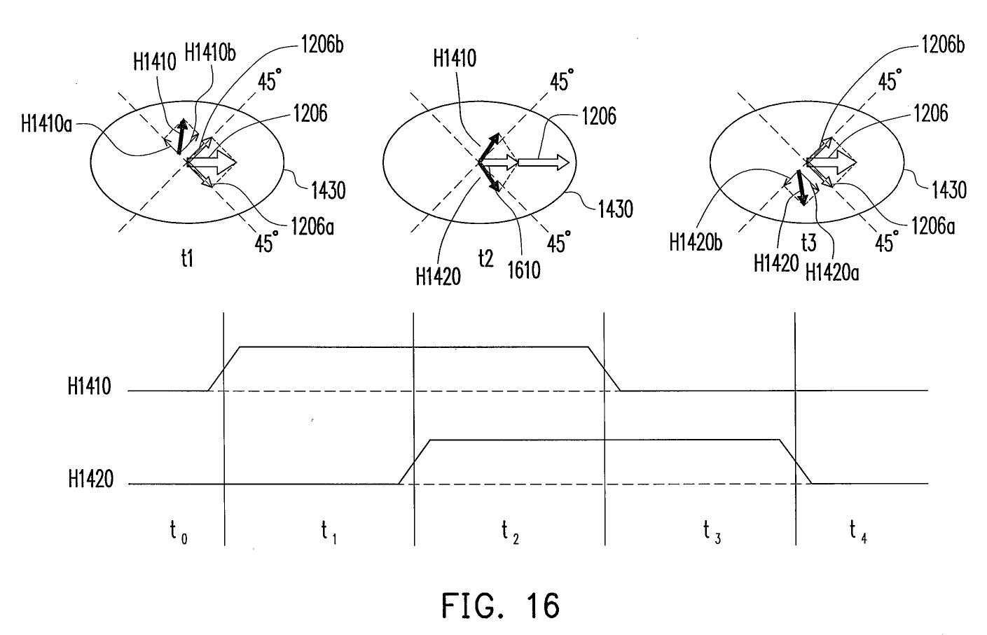

FIG. 16 is a vector diagram of the bias field and the external magnetic fields according to an embodiment of the present invention. As the included angle between the writing wire 1410 (or 1420) and the easy axis of the MTJ 1430 is smaller than 45 degrees and greater than 0 degrees (e.g., 35 degrees or other angles), the included angle between the magnetic field H1410 (or H1420) generated by the current of the writing wire 1410 (or 1420) and the easy axis of the MTJ 1430 will be greater than 45 degrees (e.g., 55 degrees or other angles).

Referring to FIG. 16, the bias field 1206 is partitioned into two vector components 1206a, 1206b at 45 degrees. In the period t₁, the writing wire 1410 will provide the magnetic field H1410 to the memory cell. As the included angle between the magnetic field H1410 and the easy axis of the MTJ 1430 is greater than 45 degrees (e.g., 55 degrees or other angles), the magnetic field H1410 have two vector components H1410a and H1410b. As the vector component 1410b is in the expected desired direction, the expected actual operating magnetic field H1410 can be reduced (i.e., the writing current of the writing wire 1410 can be reduced). Actually, the obtained effective magnetic field (i.e., 1206b +H1410b) at 45 degrees is still large enough. Moreover, as the vector component H1410a is in an opposite direction of the vector component 1206a, the vector component 1206a can be reduced (or even completely balanced out).

In the period t₃, the writing wire 1420 will provide the magnetic field H1420 to the memory cell. As the included angle between the magnetic field H1420 and the easy axis of the MTJ 1430 is greater than 45 degrees (e.g., 55 degrees or other angles), the magnetic field H1420 have two vector components H1420a and H1420b. As the vector component 1420a is in the expected desired direction, the expected actual operating magnetic field H1420 can be reduced (i.e., the writing current of the writing wire 1420 can be reduced). Actually, the obtained effective magnetic field (i.e., 1206b+H1410a) at 45 degrees is still great enough. Moreover, as the vector component H1420b is in an opposite direction of the vector component 1206b, the vector component 1206b can be reduced (or even completely balanced out).

In the above embodiment, the included angle between the writing wire 1410 (or 1420) and the easy axis of the MTJ is smaller than 45 degrees, i.e., the included angle between the writing wires 1410 and 1420 is smaller than 90 degrees. Therefore, compared with the conventional art, the present invention has an increased bias field, so the start point of the toggle operation area is closer to the zero point of the magnetic field. In the above embodiment, the included angle between the first writing wire 1410 and the easy axis of the MTJ 1430 can be −35 degrees, and the included angle between the second writing wire 1420 and the easy axis of the MTJ 1430 can be +35 degrees. The included angle between the writing wire 1410 or 1420 and the easy axis of the MTJ 1430 can be decided according to actual requirements (e.g., the intensity of the bias field H_{BIAS}) of the design. Therefore, the above embodiment increases the operation area at a low current, so as to reduce the interference when writing data. In particular, when the elements are miniaturized, the above embodiment maintains superior switching performance and adequate thermal stability.

Hereinafter, the method for manufacturing the magnetic memory 1400 or 1500 is described. First, a substrate is provided, and a first writing wire 1410 is formed above the substrate. A stack is formed above the first writing wire 1410, and the stack includes a magnetic pinned layer, a tunnel barrier insulating layer, and a magnetic free layer, so as to form an MTJ 1430. The MTJ has an easy axis. The included angle between the first writing wire 1410 and the easy axis of the MTJ 1430 is smaller than 45 degrees and greater than 0 degrees on a projected plane. A second writing wire 1420 is formed above the stack. The included angle between the second writing wire 1420 and the easy axis of the MTJ 1430 is smaller than 45 degrees and greater than 0 degrees on the projected plane.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A magnetic memory, comprising:
a stack, comprising a magnetic pinned layer, a tunnel barrier insulating layer, and a magnetic free layer, so as to form a magnetic tunnel junction (MTJ), wherein the MTJ has an easy axis;
a first writing wire, disposed under the stack, wherein an included angle between the first writing wire and the easy axis of the MTJ is smaller than 45 degrees and greater than 0 degrees on a projected plane; and
a second writing wire, disposed above the stack, wherein an included angle between the second writing wire and the easy axis of the MTJ is smaller than 45 degrees and greater than 0 degrees on the projected plane.

2. The magnetic memory as claimed in claim 1, wherein the magnetic pinned layer comprises:
a first ferromagnetic layer;
a first non-magnetic metal layer; and
a second ferromagnetic layer.

3. The magnetic memory as claimed in claim 2, wherein intensities of magnetic fields of the first ferromagnetic layer and the second ferromagnetic layer are different.

4. The magnetic memory as claimed in claim 1, wherein the magnetic pinned layer is a synthetic anti-ferromagnetic (SAF) structure.

5. The magnetic memory as claimed in claim 1, wherein the magnetic pinned layer provides a bias field to the magnetic free layer.

6. The magnetic memory as claimed in claim 1, wherein the magnetic free layer comprises:
a third ferromagnetic layer;
a second non-magnetic metal layer; and
a fourth ferromagnetic layer.

7. The magnetic memory as claimed in claim 1, wherein the magnetic free layer is a synthetic anti-ferromagnetic (SAF) structure.

8. A method for manufacturing a magnetic memory, comprising:
providing a substrate;
forming a first writing wire above the substrate;
forming a stack above the first writing wire, the stack including a magnetic pinned layer, a tunnel barrier insulating layer, and a magnetic free layer, so as to form a magnetic tunnel junction (MTJ), wherein the MTJ has an easy axis, and an included angle between the first writing wire and the easy axis of the MTJ is smaller than 45 degrees and greater than 0 degrees on a projected plane; and
forming a second writing wire above the stack, wherein an included angle between the second writing wire and the easy axis of the MTJ is smaller than 45 degrees and greater than 0 degrees on the projected plane.

9. The method for manufacturing a magnetic memory as claimed in claim 8, wherein the magnetic pinned layer comprises a first ferromagnetic layer, a first non-magnetic metal layer, and a second ferromagnetic layer.

10. The method for manufacturing a magnetic memory as claimed in claim 9, wherein intensities of magnetic fields of the first ferromagnetic layer and the second ferromagnetic layer are different.

11. The method for manufacturing a magnetic memory as claimed in claim 8, wherein the magnetic pinned layer provides a bias field to the magnetic free layer.

12. The method for manufacturing a magnetic memory as claimed in claim 8, wherein the magnetic free layer is a synthetic anti-ferromagnetic (SAF) structure.

13. The method for manufacturing a magnetic memory as claimed in claim 8, wherein the magnetic pinned layer comprises a third ferromagnetic layer, a second non-magnetic metal layer, and a fourth ferromagnetic layer.

14. The method for manufacturing a magnetic memory as claimed in claim 8, wherein the magnetic free layer is a synthetic anti-ferromagnetic (SAF) structure.
